(19) United States
(12) Patent Application Publication
(10) Pub. No.: US 2025/0337043 A1
(43) Pub. Date: Oct. 30, 2025

(54) BATTERY PACK, BATTERY COOLING SYSTEM AND VEHICLE INCLUDING THE SAME

(71) Applicants: Hyundai Motor Company, Seoul (KR); Kia Corporation, Seoul (KR)

(72) Inventors: Min Je Jo, Seoul (KR); Kyung Sang Yu, Hwaseong-si (KR); Jin Won Kim, Pyeongtaek-si (KR); Jun Young Lim, Seoul (KR)

(21) Appl. No.: 18/808,848

(22) Filed: Aug. 19, 2024

(30) Foreign Application Priority Data
Apr. 29, 2024 (KR) 10-2024-0056800

(51) Int. Cl. H01M 10/6563; B60K 1/04; B60K 11/06; B60K 15/03; B60K 15/063; B60L 50/75; H01M 8/04082; H01M 10/613; H01M 10/625; H01M 16/00; H01M 50/211

(52) U.S. Cl. CPC H01M 10/6563; B60K 1/04; B60K 11/06; B60K 15/063; H01M 8/04201; H01M 10/613; H01M 10/625; H01M 16/006; H01M 50/211; B60K 2001/0433; B60K 2015/03315; B60K 2015/0633; B60L 50/75; H01M 2220/20; H01M 2250/20; H01M 2250/402

(57) ABSTRACT

An embodiment battery cooling system for a vehicle includes a battery pack and a plurality of battery cells disposed in the battery pack, wherein the battery pack includes a first air inlet and a second air inlet disposed in both ends in a width direction, respectively, and a first air outlet and a second air outlet disposed inside in the width direction, respectively.

### CROSS-REFERENCE TO RELATED APPLICATIONS

This application claims the benefit of Korean Patent Application No. 10-2024-0056800, filed on Apr. 29, 2024, which application is hereby incorporated herein by reference in its entirety.

### TECHNICAL FIELD

The present disclosure relates to a battery pack, a battery cooling system for a vehicle, and a vehicle including the same.

### BACKGROUND

As not only internal combustion engine vehicles, but also fuel cell electric vehicles (FCVs, FCEVs) including hydrogen vehicles, hybrid vehicles (HEVs), electric vehicles (EVs), and the like continue to develop, more power and higher performance are required.

Recently, hybrid vehicles are moving toward plug-in hybrid vehicles (PHEVs), and plug-in hybrid vehicles are gradually requiring larger capacity batteries to increase the driving distance provided by the motor.

In addition, hydrogen fuel cell vehicles may also use lithium-ion high-voltage batteries to meet the high output requirements of the motor. As the output required from a battery in the motor increases, the capacity of the existing low-capacity battery is required to satisfy the high performance of the battery.

Accordingly, the size of a battery may be increased to increase capacity, and in detail, when applying hydrogen electric vehicles to the same vehicle type rather than to other electric vehicles (for example, existing HEVs), it may be difficult to utilize space because the space occupied by a hydrogen tank is required.

In detail, the space occupied by batteries in electric vehicles, fuel cell vehicles, or the like according to the related art is increasing due to the demand for large-capacity batteries, and along therewith, the use of space to cool the batteries is also becoming very important.

### SUMMARY

An embodiment of the present disclosure provides a battery pack, a battery cooling system for a vehicle, and a vehicle including the same, in which cooling efficiency of a battery may be improved while increasing the space utilization of the vehicle.

According to an embodiment of the present disclosure, a battery cooling system for a vehicle includes a battery pack and a plurality of battery cells provided in the battery pack. The battery pack includes a first air inlet and a second air inlet provided in both ends in the width direction, respectively, and a first air outlet and a second air outlet provided inside in the width direction, respectively.

The battery pack may have two first and second cooling rooms on both sides thereof in the width direction, and the plurality of battery cells may be divided and provided into the first and second cooling rooms.

The first and second cooling rooms may include a first guide and a second guide of which air flow paths become narrower from an outer side to an inner side in the width direction, respectively.

The first and second guides may be implemented by a shape in which an upper surface of the battery pack slopes from top to bottom, as approaching from an outside to an inside in the width direction.

The first and second air inlets may be connected to the first and second cooling rooms, respectively, and the first and second air outlets may be connected to the first and second cooling rooms, respectively.

The first and second air inlets may be provided in upper end portions of the battery pack in a thickness direction, and the first and second air outlets may be provided in lower end portions of the battery pack in the thickness direction.

The first and second air outlets may be provided at a rear of the battery pack in a longitudinal direction.

The first and second air outlets may be provided in inner ends of the first and second cooling rooms in the width direction, respectively.

The first and second air inlets may be provided with first and second inlet ducts connected thereto, the first and second air outlets may be provided with first and second outlet ducts connected thereto, and the first and second outlet ducts may be provided with a first cooling fan and a second cooling fan.

The plurality of battery cells may be divided into predetermined units and included in and provided as a plurality of battery modules.

According to an embodiment of the present disclosure, a battery pack includes a housing implementing a first cooling room and a second cooling room on both sides thereof in a width direction and a plurality of battery cells divided into and provided in the first and second cooling rooms. The first cooling room is provided with a first air inlet and a first air outlet on both sides thereof in the width direction. The second cooling room is provided with a second air inlet and a second air outlet on both sides thereof in the width direction.

The first and second cooling rooms may include a first guide and a second guide of which upper surfaces slope from top to bottom and of which air flow paths narrow, as approaching from an outside to an inside in the width direction.

The first and second air inlets may be respectively provided in upper end portions of the housing in a thickness direction, and the first and second air outlets may be respectively provided in lower end portions of the housing in the thickness direction.

The first and second air inlets may be respectively provided at outer ends of the first and second cooling rooms in the width direction, and the first and second air outlets may be respectively provided at inner ends of the first and second cooling rooms in the width direction.

According to an embodiment of the present disclosure, a vehicle includes a battery cooling system. The battery cooling system includes a battery pack and a plurality of battery cells provided inside the battery pack. The battery pack includes a first air inlet and a second air inlet respectively provided at both ends in the width direction and a first air outlet and a second air outlet respectively provided inwardly in the width direction.

The vehicle may include a plurality of hydrogen fuel tanks, and the battery pack may be provided between any two of the plurality of hydrogen fuel tanks and may at least partially overlap the hydrogen fuel tanks in a front-back direction.

The first and second air inlets may be provided with and connected to a first inlet duct and a second inlet duct, the first and second air outlets may be provided with and connected to a first outlet duct and a second outlet duct, the battery pack may be provided with a seat in front thereof, and end portions of the first and second inlet ducts may be provided on outsides of both ends of the seat.

The first and second outlet ducts may be bent in directions of both ends of the housing in the width direction and then extend rearward.

The battery pack may be a high voltage battery, and a low-voltage battery having a voltage lower than a voltage of the high-voltage battery may be provided between the battery pack and the seat.

The low-voltage battery may be provided to be higher than the plurality of hydrogen fuel tanks in a thickness direction.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIG. 1 is a perspective view of a battery cooling system for a vehicle according to an embodiment;

FIG. 2 is a plan view of a battery cooling system for a vehicle according to an embodiment;

FIG. 3 is an exploded perspective view of an air inlet and an inlet duct coupled thereto applied to a battery cooling system for a vehicle according to an embodiment;

FIG. 4 is an exploded perspective view of an air outlet and an outlet duct coupled thereto applied to a battery cooling system for a vehicle according to an embodiment;

FIG. 5A is a perspective view of a battery pack according to an embodiment;

FIG. 5B is an exploded perspective view of FIG. 5A;

FIG. 6A is an example of a battery module applied to a battery cooling system for a vehicle according to an embodiment;

FIG. 6B is an exploded perspective view of the battery module illustrated in FIG. 6A;

FIGS. 7A and 7B are reference diagrams schematically illustrating the flow of cooling air in a cross-sectional view of a battery cooling system for a vehicle according to an embodiment;

FIG. 8 is a reference diagram schematically illustrating the flow of cooling air in a cross-sectional view of a battery pack applied to a battery cooling system for a vehicle according to an embodiment;

FIG. 9 is an example of a battery cooling system for a vehicle installed in a vehicle according to an embodiment;

FIGS. 10 and 11 are reference diagrams illustrating the flow of cooling air implemented in a wheel base of a vehicle on which a battery cooling system for a vehicle is installed according to an embodiment;

FIG. 12 is a reference diagram schematically illustrating the flow of cooling air in a cross-sectional view of a vehicle equipped with a battery cooling system for a vehicle according to an embodiment;

FIG. 13 is a reference diagram illustrating a side view of a vehicle on which a battery cooling system for a vehicle according to an embodiment is installed; and

FIG. 14 is a reference diagram illustrating an example of securing space in a wheel base of a vehicle in which a battery cooling system for a vehicle is installed according to an embodiment.

### DETAILED DESCRIPTION OF ILLUSTRATIVE EMBODIMENTS

Since the present disclosure may make various changes and have various embodiments, specific embodiments will be illustrated in the drawings and described in detail. However, this is not intended to limit the present disclosure to specific embodiments, and it should be understood to include all changes, equivalents, and substitutes included in the spirit and technical scope of the present disclosure.

Terms such as first, second, and the like may be used to describe various components, but the components should not be limited by the terms. The above terms are used only for the purpose of distinguishing one component from another. For example, a first component may be named a second component, and similarly, the second component may also be named a first component without departing from the scope of the present disclosure. The term ‘and/or’ includes any combination of a plurality of related stated items or any of a plurality of related stated items.

Terms such as unit, part, portion and the like may be used to describe various components, but the components should not be limited by the terms. The above terms may refer to not only a physically/visually distinct configuration, but they may also describe the function or configuration of the corresponding part even if the distinction/division is not clear.

The terms used in this application are only used to describe specific embodiments and are not intended to limit the present disclosure. Singular expressions include plural expressions unless the context clearly dictates otherwise. In this application, terms such as “comprise,” “include,” and “have” are intended to designate the presence of features, numbers, steps, operations, components, parts, or combinations thereof described in the specification, and it should be understood that this does not exclude in advance the presence or addition of one or more other features, numbers, steps, operations, components, parts, or combinations thereof.

Unless otherwise defined, all terms used herein, including technical or scientific terms, have the same meaning as that which would be commonly understood by a person of ordinary skill in the technical field to which the present disclosure pertains. Terms defined in commonly used dictionaries should be interpreted as having meanings consistent with the meanings they have in the context of the relevant technology, and unless explicitly defined in this application, are not to be interpreted in an idealistic or overly formal sense.

In this specification, a vehicle refers to a variety of vehicles that move transported objects such as people, animals, or goods from a starting point to a destination. Such vehicles are not limited to vehicles that run on roads or tracks. In addition, vehicles include not only those that use fossil fuels such as gasoline and the like, but also those that use secondary batteries using electricity stored in batteries or the like, and those that use future fuels such as hydrogen.

In the description below, the terms “anterior,” “posterior,” “lateral,” “front,” “back,” “up/down,” “above,” “upper,” “top,” “below,” “lower,” “bottom,” “left/right,” and the like, used in relation to direction, are defined based on the vehicle or body of the car. In addition, terms such as first, second, and the like may be used to describe various components, but these components are not limited in order, size, location, or importance by terms such as first, second, and the like, and they are named only for the purpose of distinguishing one component from other components.

Hereinafter, preferred embodiments of the present disclosure will be described in more detail with reference to the attached drawings.

In fuel cell electric vehicles (FCVs, FCEVs) including hydrogen vehicles, hybrid vehicles (HEVs), electric vehicles (EVs), plug-in hybrid vehicles (PHEVs), and the like, as the output required by the battery in the motor increases, the battery is also required to have higher capacity to satisfy high performance. Accordingly, the space occupied by the battery is increasing, and along with this, the use of space to cool the battery is becoming very important.

A battery pack, a battery cooling system for a vehicle, and a vehicle including the same according to an embodiment may improve battery cooling efficiency while increasing space utilization. This is explained in detail below.

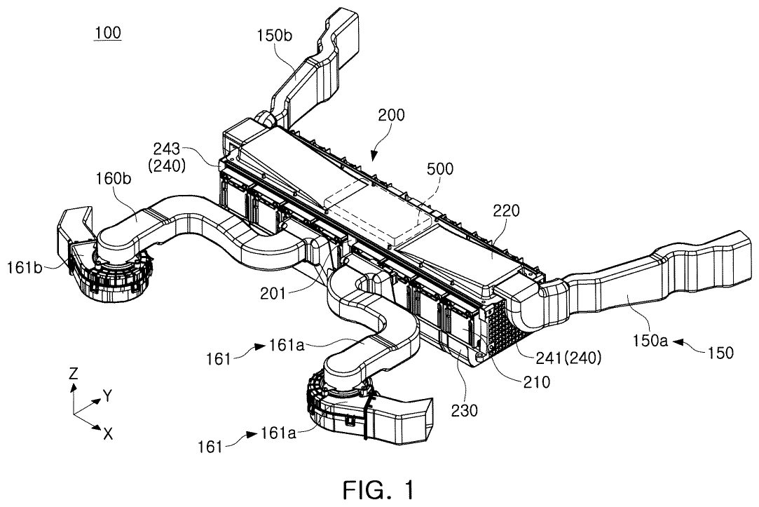

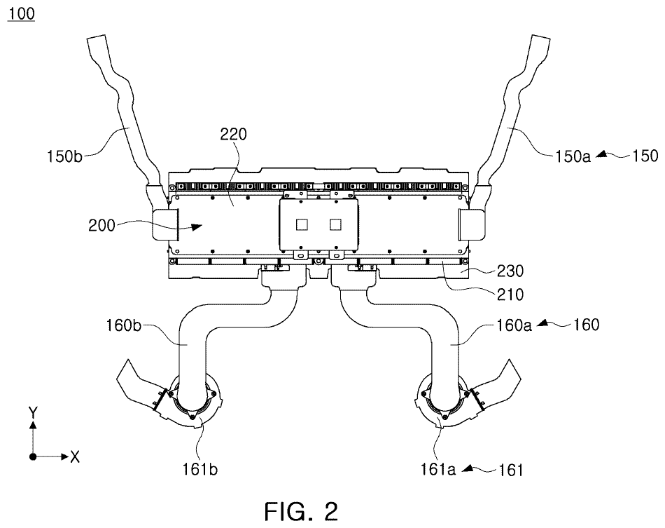

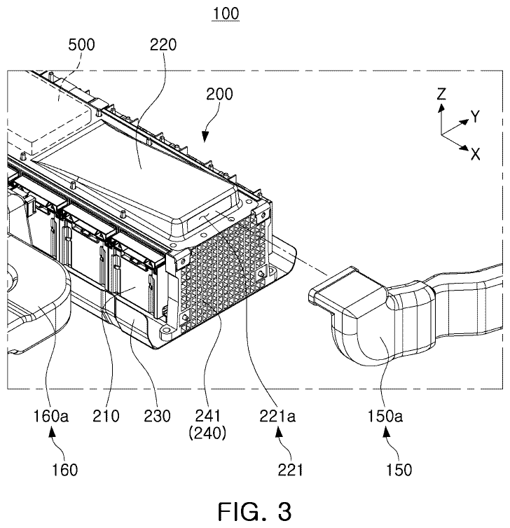

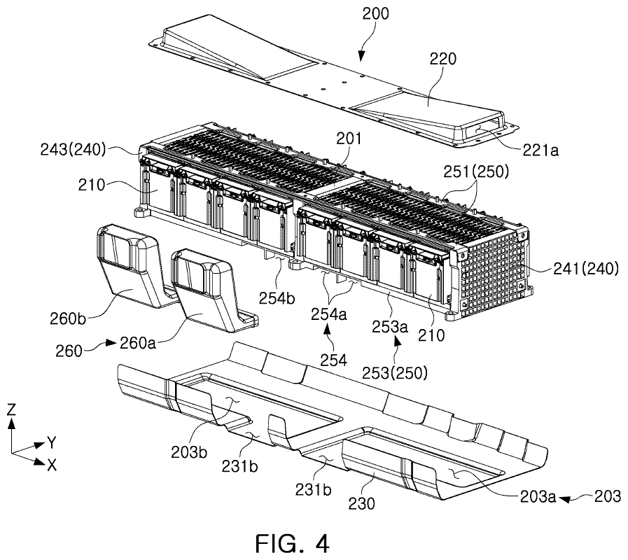

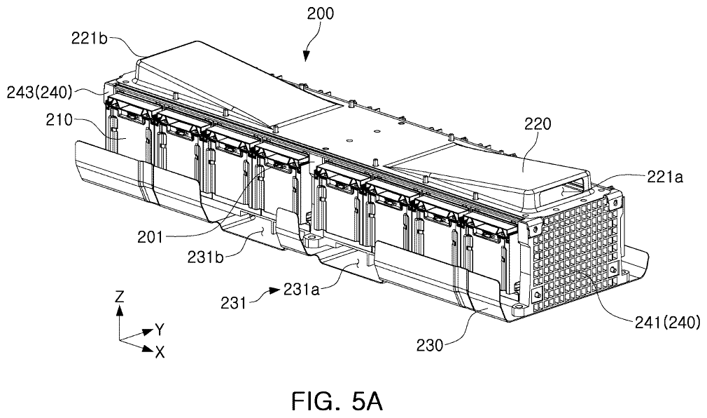

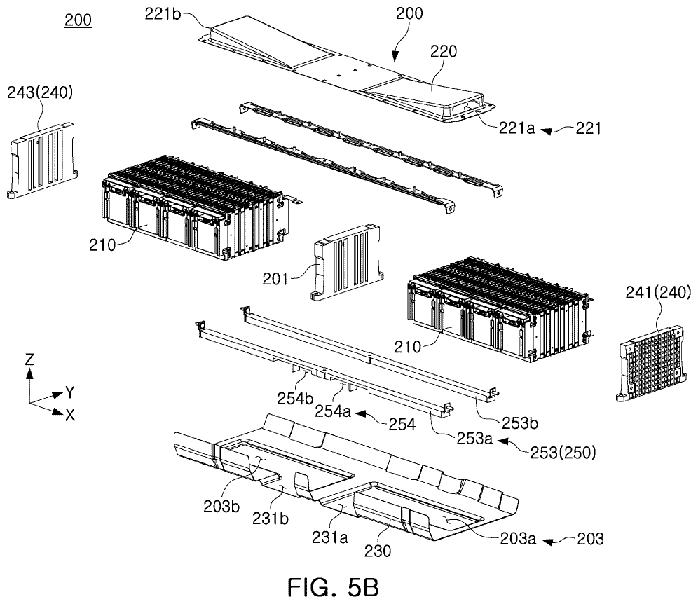

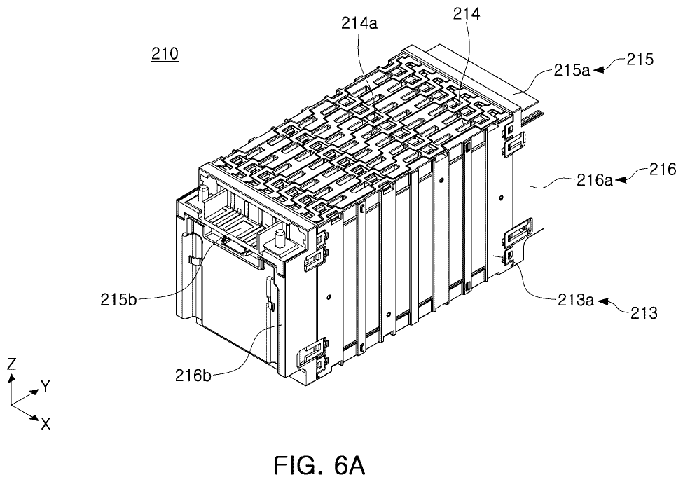

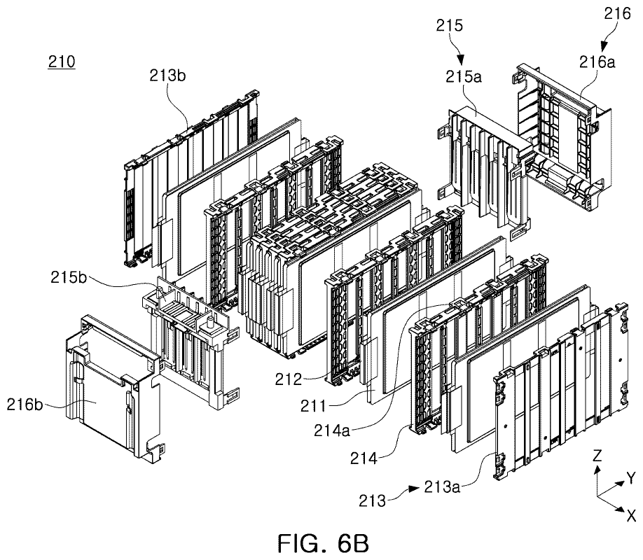

Referring to FIGS. 1 to 8, a battery cooling system 100 according to an embodiment has a structure that may cool a battery pack 200 using cooling air.

The battery cooling system 100 of one embodiment may include the battery pack 200 and a battery module 210 including a plurality of battery cells 211 provided inside the battery pack 200.

The battery pack 200 may include first and second air inlets 221 (221a and 221b) provided at both ends in the width direction and first and second air outlets 231 (231a and 231b) respectively provided on the inside in the width direction. Accordingly, the cooling air flowing into the battery pack 200 may flow from both outer sides to the inner direction in the width direction.

The battery pack 200 may be equipped with a battery management system 500.

In the description of embodiments of the present disclosure, the width direction (X-axis direction) refers to the left and right direction of the vehicle, for example, the direction perpendicular to the direction in which the vehicle moves forward or backward, the longitudinal direction (Y-axis direction) refers to the direction in which the vehicle moves forward or backward, and the thickness (height) direction (Z-axis direction) may refer to the vertical direction of the vehicle.

The battery cooling system 100 of one embodiment may be provided with first and second inlet ducts 150 (150a and 150b) connected to the battery pack 200 and into which cooling air is injected and first and second outlet ducts 160 (160a and 160b) through which cooling air is discharged.

In detail, the battery cooling system 100 of one embodiment includes the first and second inlet ducts 150a and 150b connected to the first and second air inlets 221a and 221b and may be provided with the first and second outlet ducts 160a and 160b connected to the first and second air outlets 231a and 231b.

The first and second air inlets 221a and 221b may be provided at the upper portion in the thickness direction of the battery pack 200, and the first and second air outlets 231a and 231b may be provided at the lower end of the battery pack 200 in the thickness direction. Accordingly, the cooling air flowing into the battery pack 200 may flow from the top to the bottom in the thickness direction. In detail, cooling air may flow from the ceiling direction to the wheel direction based on the vehicle.

In addition, the first and second air inlets 221a and 221b are provided approximately in the middle of the battery pack 200 in the longitudinal direction, and the first and second air outlets 231a and 231b may be provided at the rear of the battery pack 200 in the longitudinal direction. Accordingly, cooling air flowing into the battery pack 200 may flow from front to back in the longitudinal direction, and in detail, may flow from front to back based on the vehicle. Of course, although not illustrated, the first and second air inlets 221a and 221b may be provided biased toward the front in the longitudinal direction of the battery pack 200.

The first and second outlet ducts 160a and 160b may be provided with first and second cooling fans 161a and 161b that suck in cooling air. In addition, although not illustrated in the drawing, the first and second cooling fans 161a and 161b that suck in cooling air may be provided in the first and second air inlets 221a and 221b.

Since the first and second cooling fans 161a and 161b are divided into two on both sides, a sufficient cooling air intake effect may be obtained even when a small-sized cooling fan is used. Accordingly, noise that may occur from the cooling fan may be significantly reduced.

The battery pack 200 may include the battery module 210 having the plurality of battery cells 211 disposed therein, an upper housing 220 provided at the upper portion in the thickness direction of the battery module 210, and a lower housing 230 provided at the lower portion in the thickness direction of the battery module 210.

In addition, first and second side covers 240 (241 and 243) are provided at both ends of the plurality of sequentially aligned battery modules 210, and first and second brackets 250 (251 and 253) may be provided at the upper and lower parts to interconnect the first and second side covers 241 and 243 and secure the plurality of battery modules 210.

The first and second side covers 241 and 243 may be provided with a plurality of holes for cooling the outermost battery module 210. The first and second brackets 251 and 253 may be provided in a bar shape with a length in the direction in which the plurality of battery modules 210 are aligned, and there may be at least two first brackets 251 at the top and at least two second brackets 253 at the bottom. In addition, the first and second side covers 241 and 243 and the first and second brackets 251 and 253 may be screwed together.

There may be at least two lower second brackets 253 (253a and 253b), and the 2-1 bracket 253a provided at the front may be provided with openings 254 (254a and 254b) forming the air outlets 231 (231a and 231b).

The upper housing 220 may be screwed to the upper first bracket 251.

The battery module 210 includes first and second covers 216 (216a and 216b) provided on both sides in the longitudinal direction and first and second cartridges 213 (213a and 213b) provided on both sides in the width direction, and a plurality of battery cells 211 may be disposed in the internal space of battery module 210.

The first and second cartridges 213a and 213b have a plurality of openings, and the outermost battery cell 211 may be exposed through the openings.

A predetermined number of battery cells 211 may be used as unit cells, and a third cartridge 214 may be provided therebetween. The upper and lower portions of the third cartridge 214 may be provided with a plurality of through-holes 214a through which cooling air may flow.

When the first and second cartridges 213a and 213b and the third cartridge 214 may be aligned to overlap in the width direction, the upper and lower parts in the thickness direction overlap with the third cartridge 214 to form the upper and lower surfaces. In addition, the upper and lower surfaces are provided with the through-hole 214a of the third cartridge 214, which may be used as a hole through which cooling air flows.

Respective battery cells 211 may be provided with electrodes 212 on both sides thereof or one side thereof in the longitudinal direction.

In the case of respective battery cells 211, the electrodes 212 may be interconnected, on both sides in the longitudinal direction, by first and second sensing blocks 215 (215a and 215b) provided between the first and second covers 216 (216a and 216b) and the battery cell 211. As a result, the plurality of battery cells 211 inside the battery module 210 may be connected in series or in parallel.

As an example, the battery module 210 of this embodiment includes two battery cells 211 connected in parallel to one unit cell, and eight unit cells may be connected to each other in series (a total of 16 battery cells 211). Accordingly, the battery module 210 of this embodiment may form a 2-parallel 8-series structure.

In the battery pack 200 of this embodiment, a housing having an internal space 203 may be implemented by the first and second covers 216a and 216b provided on both sides of the battery module 210 in the longitudinal direction and by the upper housing 220 and the lower housing 230 covering the upper and lower portions of the battery module 210. The housing may form the exterior of the battery pack 200. Additionally, a plurality of battery cells 211 may be provided in the internal space 203.

The battery pack 200 of this embodiment may be provided with a partition wall 201 at approximately the middle portion in the width direction, and accordingly, the internal space 203 may be divided into first and second internal spaces 203a and 203b. The two first and second internal spaces 203a and 203b provided on both sides of the battery pack 200 in the width direction may be used as first and second cooling rooms 203a and 203b. The first and second cooling rooms 203a and 203b may have the same space size.

The plurality of battery cells 211 may be provided in the plurality of battery modules 210, and the plurality of battery modules 210 may be divided into the first and second cooling rooms 203a and 203b. The number of battery modules 210 provided in the first and second cooling rooms 203a and 203b may be the same. Accordingly, the number of battery cells 211 provided in the first and second cooling rooms 203a and 203b may also be the same.

In this embodiment, as an example, a structure in which four battery modules 210 are provided in each of the first and second cooling rooms 203a and 203b is disclosed. Since each battery module 210 is provided with eight unit cells each having two battery cells 211, one battery module 210 may have a total of 16 battery cells 211. In addition, one battery pack 200 is provided with four battery modules 210 in each of the first and second cooling rooms 203a and 203b, and thus, may have a total of 128 battery cells 211.

The first and second cooling rooms 203a and 203b may be provided with a guide 223 whose air flow path becomes narrower from the outer side to the inner side in the width direction. The guide 223 may include first and second guides 223a and 223b provided in the first and second cooling rooms 203a and 203b, respectively. The first and second guides 223a and 223b may be provided on the inner surface of the upper housing 220 to face the upper surfaces of the battery modules 210 in the thickness direction. For example, the first and second guides 223a and 223b may be implemented in such a way that the inner surface of the upper housing 220 forming the battery pack 200 is inclined from the top to the bottom in the width direction from the outside to the inside.

In addition, the first and second air inlets 221a and 221b are connected to the first and second cooling rooms 203a and 203b, respectively, and the first and second air outlets 231a and 231b may be connected to the first and second cooling rooms 203a and 203b, respectively.

The first and second air inlets 221a and 221b are respectively provided at the outer ends of the first and second cooling rooms 203a and 203b in the width direction, and the first and second air outlets 231a and 231b may be respectively provided at inner ends of the first and second cooling rooms 203a and 203b in the width direction. Accordingly, the cooling air flowing into each of the first and second cooling rooms 203a and 203b may flow from the outside to the inside in the width direction.

The first and second air inlets 221a and 221b may be provided at the upper portions in the thickness direction of the first and second cooling rooms 203a and 203b, and the first and second air outlets 231a and 231b may be provided at the lower portions of the first and second cooling rooms 203a and 203b in the thickness direction. Accordingly, the cooling air flowing into the first and second cooling rooms 203a and 203b, respectively, may flow from the top to the bottom in the thickness direction.

In addition, the first and second air inlets 221a and 221b are provided at the front of the first and second cooling rooms 203a and 203b in the longitudinal direction, and the first and second air outlets 231a and 231b may be provided at the rear of the first and second cooling rooms 203a and 203b in the longitudinal direction. Accordingly, the cooling air flowing into the first and second cooling rooms 203a and 203b, respectively, may flow from front to back in the longitudinal direction, and in detail, may flow from the front to the back based on the vehicle.

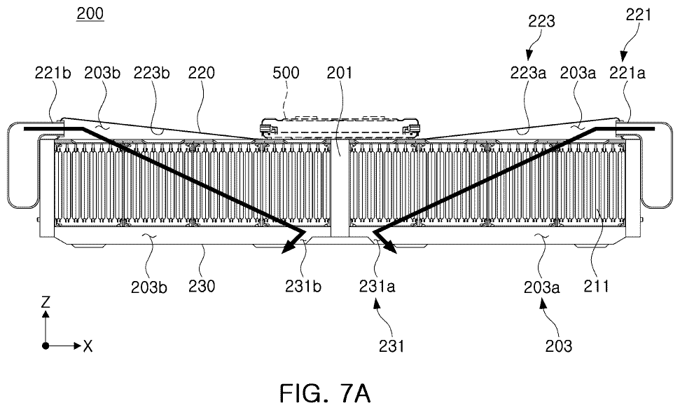

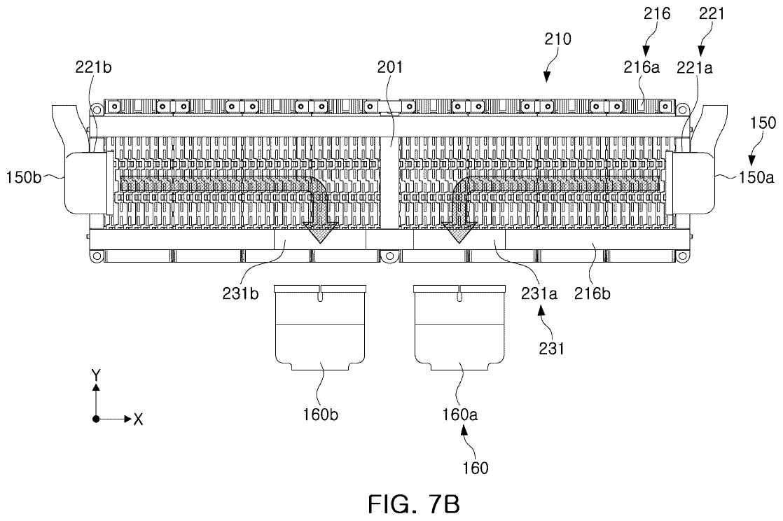

Referring to FIGS. 7A and 7B, the path in which the cooling air flowing into the first and second air inlets 221a and 221b of the battery pack 200 of this embodiment cools the battery cells 211 in the first and second cooling rooms 203a and 203b and exits through the first and second air outlets 231a and 231b is indicated by arrows.

First, referring to FIG. 7A, it can be seen that the cooling air flowing into the first and second cooling rooms 203a and 203b flows from the top to the bottom in the thickness direction (Z-axis direction) and flows from the outside to the inside in the width direction (X-axis direction). Also, referring to FIG. 7B, it can be seen that cooling air flowing into the first and second cooling rooms 203a and 203b flows from the outside to the inside in the width direction (X-axis direction) and flows from front to back in the longitudinal direction (Y-axis direction).

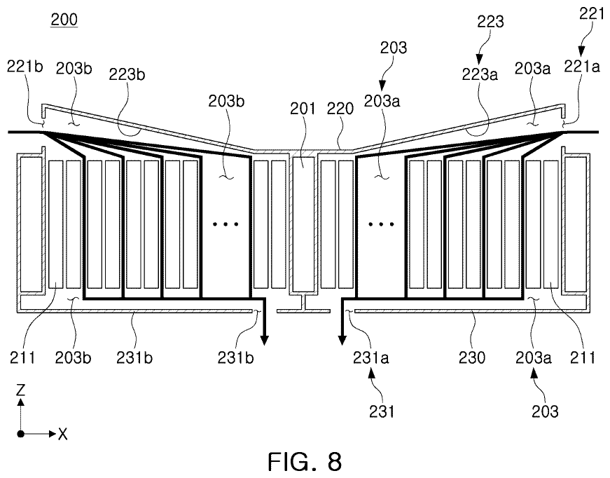

Referring to FIG. 8, the path in which cooling air flowing into the first and second air inlets 221a and 221b of the battery pack 200 of this embodiment cools the battery cells 211 in the first and second cooling rooms 203a and 203b and exits through the first and second air outlets 231a and 231b is indicated by arrows. The illustration in FIG. 8 is an example illustrating the flow of cooling air illustrated in FIG. 7A in more detail.

Basically, the cooling air flowing into the first and second cooling rooms 203a and 203b flows from the top to the bottom in the thickness direction (Z-axis direction) and flows from the outside to the inside in the width direction (X-axis direction). In addition, it can be seen that cooling air flows between one unit cell composed of two battery cells 211 in the first and second cooling rooms 203a and 203b. Accordingly, all battery cells 211 come into contact with cooling air, so efficient cooling of the battery cells 211 may be obtained.

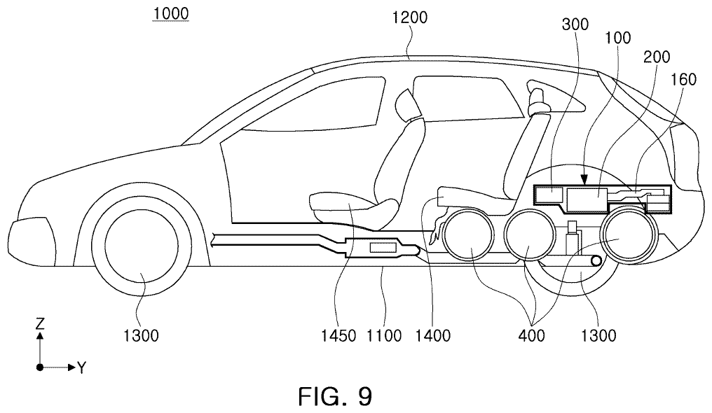

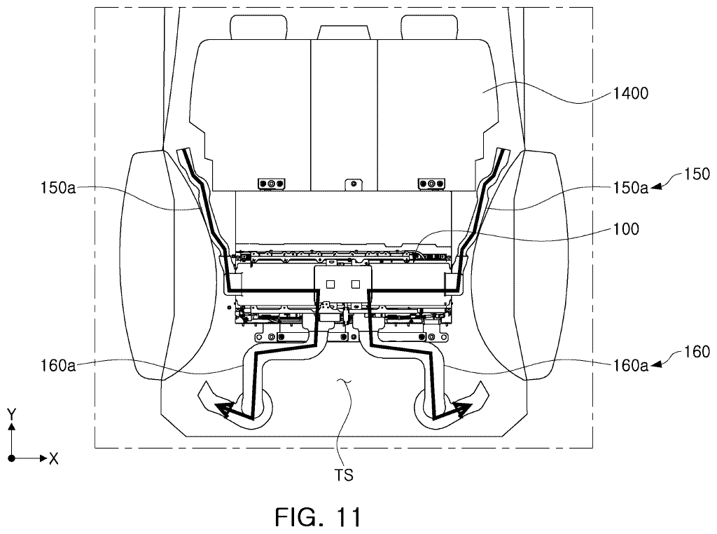

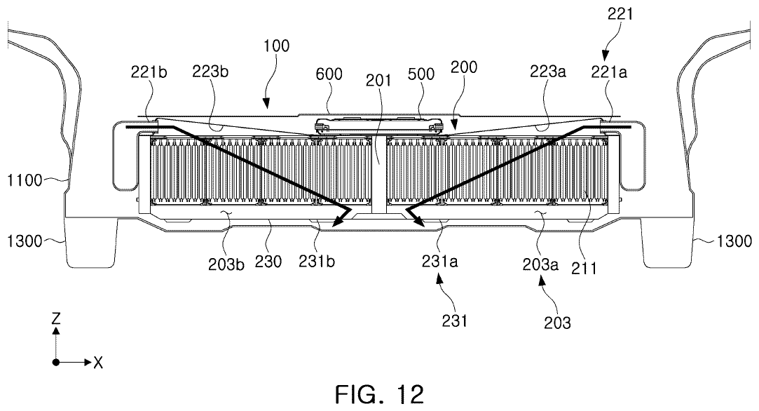

Referring to FIGS. 9 to 14, an example in which the battery cooling system 100 according to an embodiment is installed in a vehicle 1000 is disclosed.

The vehicle 1000 of an embodiment may include a wheel base 1100, a car body 1200 mounted on the wheel base 1100, and wheels 1300 provided on the wheel base 1100. Additionally, the wheel base 1100 is provided with seats 1400 and 1450 to be installed inside the car body 1200, and the seats may include a first-row seat 1450 and a second-row seat 1400.

The vehicle 1000 of one embodiment may include the battery cooling system 100. The structure of the battery cooling system 100 that may be applied to this vehicle 1000 is the same as that described above with reference to FIGS. 1 to 8, so a detailed description will be omitted. The same configuration will be described with reference to the same reference numerals.

The vehicle 1000 of this embodiment may be a hybrid vehicle (HEV), an electric vehicle (EV), a fuel cell electric vehicle (FCV, FCEV) including a hydrogen vehicle, or the like.

The battery cooling system 100 may be installed in the vehicle 1000, and in detail, may be placed behind the second-row seat 1400 of the vehicle 1000.

The battery cooling system 100 may include the battery pack 200 and the battery management system 500 that controls the battery pack 200.

Additionally, the vehicle 1000 may be provided with a cover 600 that covers the battery pack 200 and a low-voltage battery 300.

Additionally, the end portions of the first and second inlet ducts 150a and 150b may extend to the outside of both ends of the second-row seat 1400. The end portions of the first and second inlet ducts 150a and 150b are disposed to face forward in the longitudinal direction to facilitate the introduction of cooling air into a vehicle moving forward.

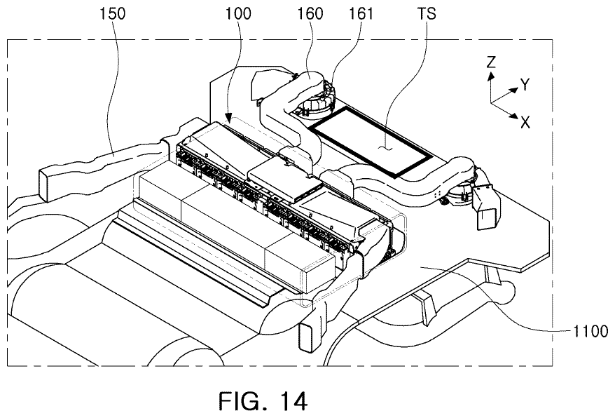

Referring to FIG. 14, the first and second outlet ducts 160a and 160b may be bent toward both ends of the housing of the battery pack 200 in the width direction and then disposed to extend rearward. Since the first and second outlet ducts 160a and 160b are bent in both width directions and then extended rearward, a trunk space TS may be secured between the first and second outlet ducts 160a and 160b. Additionally, this space may be equipped with a tire repair kit (TMK), fire extinguisher, V2L connector (charging cable for electric vehicles), tripod, or the like.

The end portions of the first and second outlet ducts 160a and 160b are disposed to face rearward in the longitudinal direction or downward (toward the ground) in the thickness direction to facilitate the discharge of cooling air from a vehicle moving forward.

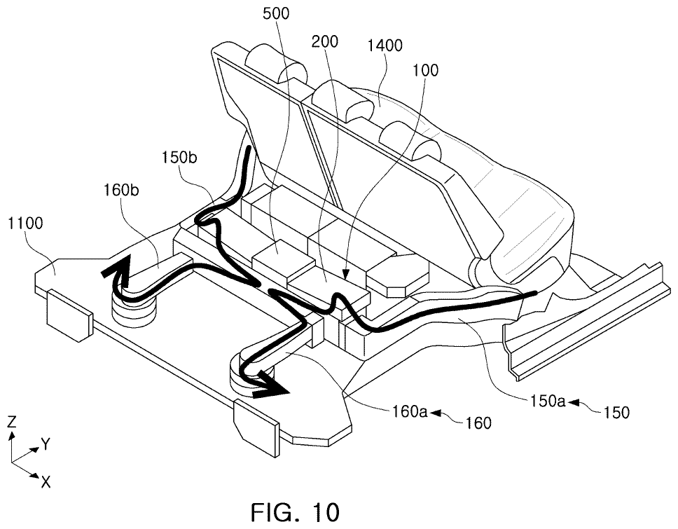

Referring to FIGS. 10 to 12, cooling air flowing into the ends of the first and second inlet ducts 150a and 150b extending outwardly from both ends of the second-row seat 1400 flows into the first and second cooling rooms 203a and 203b through the first and second air inlets 221a and 221b and penetrates between all battery cells 211 and is discharged to the first and second outlet ducts 160a and 160b through the first and second air outlets 231a and 231b, which are indicated by arrows.

Two arrows may be formed on both sides in the width direction, and it can be seen that the cooling air passes respectively through the first and second cooling rooms 203a and 203b that are classified as two on both sides inside the battery pack 200 and then is disposed. Accordingly, efficient cooling may be obtained.

The battery pack 200 of this embodiment may be a high-voltage battery (for example, 240V or the like), and the vehicle may be further equipped with a low-voltage battery (for example, 12V).

For example, the battery pack 200 of this embodiment may be a high voltage battery (for example, 240V or the like), and the low-voltage battery 300 with a lower voltage than the battery pack 200, which is a high-voltage battery, may be further provided between the battery pack 200 and the second-row seat 1400.

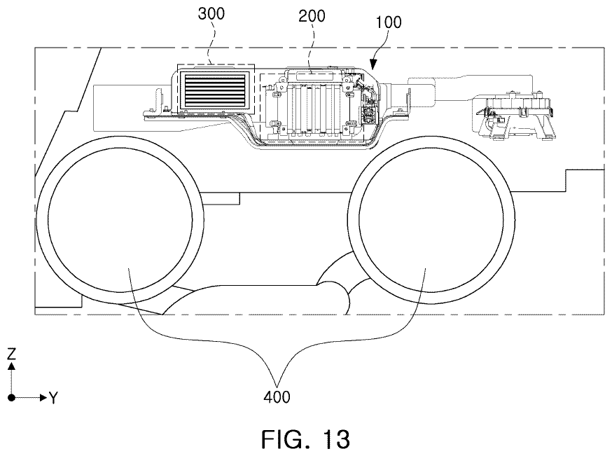

Meanwhile, referring to FIG. 13, the vehicle 1000 of this embodiment may be a hydrogen electric vehicle, and accordingly, the vehicle 1000 is equipped with a plurality of hydrogen fuel tanks 400, and the battery pack 200 may be provided between any two of the plurality of hydrogen fuel tanks 400 so that at least a portion of the battery pack 200 overlaps the hydrogen fuel tank 400 in the front-back direction. For example, the lower end of the battery pack 200 may be provided lower than the upper end of the hydrogen fuel tank 400 in the thickness direction.

The battery pack 200 of this embodiment is a high-voltage battery (for example, 240V or the like) and thus has a large capacity and may be provided in a large volume, and considering the thickness or volume thereof, the battery pack may be placed between a plurality of hydrogen fuel tanks 400 so that it may be installed in a more secured space in the thickness direction. On the other hand, the low-voltage battery 300 has a small volume and may thus be installed on top of one or more of the plurality of hydrogen fuel tanks 400 in the thickness direction.

As set forth above, a battery pack, a battery cooling system for a vehicle, and a vehicle including the same according to an embodiment have the effect of implementing excellent cooling performance while increasing space utilization.

A battery pack, a battery cooling system for a vehicle, and a vehicle including the same according to an embodiment may be implemented through simple structural changes, and therefore, performance thereof may be improved without major changes compared to the related art. Accordingly, the effect of substantially reducing costs may be obtained.

While example embodiments have been illustrated and described above, it will be apparent to those skilled in the art that modifications and variations could be made without departing from the scope of the present disclosure as defined by the appended claims.

What is claimed is:

1. A battery cooling system for a vehicle, the battery cooling system comprising:
a battery pack comprising:
a first air inlet and a second air inlet disposed in both ends in a width direction, respectively; and
a first air outlet and a second air outlet disposed inside in the width direction, respectively; and
a plurality of battery cells disposed in the battery pack.

2. The battery cooling system of claim 1, wherein:
the battery pack further comprises first and second cooling rooms on both sides of the battery pack in the width direction; and
the plurality of battery cells are divided and disposed in the first and second cooling rooms.

3. The battery cooling system of claim 2, wherein the first and second cooling rooms comprise first and second guides, respectively, of which air flow paths become narrower from an outer side to an inner side in the width direction.

4. The battery cooling system of claim 3, wherein the first and second guides are implemented by a shape in which an upper surface of the battery pack slopes from top to bottom, as approaching from an outside to an inside in the width direction.

5. The battery cooling system of claim 2, wherein:
the first and second air inlets are connected to the first and second cooling rooms, respectively; and
the first and second air outlets are connected to the first and second cooling rooms, respectively.

6. The battery cooling system of claim 5, wherein the first and second air outlets are disposed in inner ends of the first and second cooling rooms in the width direction, respectively.

7. The battery cooling system of claim 1, wherein:
the first and second air inlets are disposed in upper end portions of the battery pack in a thickness direction; and
the first and second air outlets are disposed in lower end portions of the battery pack in the thickness direction.

8. The battery cooling system of claim 1, wherein the first and second air outlets are disposed at a rear of the battery pack in a longitudinal direction.

9. The battery cooling system of claim 1, wherein:
the first and second air inlets comprise first and second inlet ducts connected thereto, respectively;
the first and second air outlets comprise first and second outlet ducts connected thereto, respectively; and
the first and second outlet ducts comprise first and second cooling fans, respectively.

10. The battery cooling system of claim 1, wherein the plurality of battery cells is divided into predetermined units and included in and provided as a plurality of battery modules.

11. A battery pack comprising:
a housing comprising a first cooling room and a second cooling room on both sides of the housing in a width direction, wherein the first cooling room comprises a first air inlet and a first air outlet on both sides of the housing in the width direction, and the second cooling room comprises a second air inlet and a second air outlet on both sides of the housing in the width direction; and
a plurality of battery cells divided into and disposed in the first and second cooling rooms.

12. The battery pack of claim 11, wherein the first and second cooling rooms comprise first and second guides, respectively, of which upper surfaces slope from top to bottom and of which air flow paths narrow, as approaching from an outside to an inside in the width direction.

13. The battery pack of claim 11, wherein:
the first and second air inlets are disposed in upper end portions of the housing in a thickness direction; and
the first and second air outlets are disposed in lower end portions of the housing in the thickness direction.

14. The battery pack of claim 11, wherein:
the first and second air inlets are disposed in outer ends of the first and second cooling rooms in the width direction, respectively; and
the first and second air outlets are disposed in inner ends of the first and second cooling rooms in the width direction, respectively.

15. A vehicle comprising:
a vehicle body; and
a battery cooling system within the vehicle body comprising:
a battery pack comprising first and second air inlets disposed at both ends in a width direction, respectively, and first and second air outlets disposed inwardly in the width direction, respectively; and
a plurality of battery cells disposed inside the battery pack.

16. The vehicle of claim 15, further comprising a plurality of hydrogen fuel tanks, wherein the battery pack is disposed between any two of the plurality of hydrogen fuel tanks and at least partially overlaps the hydrogen fuel tanks in a front-back direction.

17. The vehicle of claim 16, wherein:
the first and second air inlets comprise first and second inlet ducts, respectively;
the first and second air outlets comprise first and second outlet ducts;
a seat is disposed in front of the battery pack; and
end portions of the first and second inlet ducts are disposed on outsides of both ends of the seat, respectively.

18. The vehicle of claim 17, wherein the first and second outlet ducts are bent in directions of both ends of a housing of the battery pack in the width direction and then extend rearward.

19. The vehicle of claim 17, wherein:
the battery pack is a high-voltage battery; and
a low-voltage battery having a voltage lower than a voltage of the high-voltage battery is disposed between the battery pack and the seat.

20. The vehicle of claim 19, wherein the low-voltage battery is disposed higher than the plurality of hydrogen fuel tanks in a thickness direction.
